(19) United States
(12) Patent Application Publication
(10) Pub. No.: US 2011/0164317 A1
(43) Pub. Date: Jul. 7, 2011

(54) CONTRAST-INCREASING REAR PROJECTION SCREEN

(75) Inventors: Michael Vergohl, Vor Der Elm (DE); Frank Neumann, Braunschweig (DE); Christoph Rickers, Braunschweig (DE)

(73) Assignee: Fraunhofer-Gesellschaft zur Forderung der angewandten Forschung e.V., Munchen (DE)

(21) Appl. No.: 11/817,776

(22) PCT Filed: Mar. 3, 2006
(86) PCT No.: PCT/EP2006/001958

§ 371 Date: Sep. 25, 2009

(30) Foreign Application Priority Data
Mar. 4, 2005 (DE) 10 2005 010 523.8

(51) Int. Cl. G03B 21/56

(52) U.S. Cl. 359/460

(57) ABSTRACT

Rear projection device, rear projection screen and associated method for representing static or moving images, for improving the representation, particularly in ambient light, comprising at least one projection screen (107) and at least one light source (101) that is provided for rear projection onto a projection screen (107) adjusted to be spectral-selectively absorbing for an ambient light, at least outside of at least one narrowband transmission spectral range, wherein projection screen (107) permits a transmission of useful light inside the transmission spectral range.

### CROSS-REFERENCE TO RELATED APPLICATIONS

This application is the U.S. national phase of International Patent Application PCT/EP2006/001958 filed Mar. 3, 2006, which claims priority to German Patent Application DE 10 2005 010 523.8-51 filed Mar. 4, 2005.

### FIELD OF THE INVENTION

The present invention concerns a rear projection device as well as a rear projection screen and an associated method for representing static and/or moving images.

### BACKGROUND OF THE INVENTION

Devices and methods for, in particular, the large area or rear projection for representing static and/or moving images are widely known.

The problem of the present invention is to improve a representation of static or moving images on an image plane, particularly in ambient light such as daylight or artificial room lighting.

### SUMMARY OF THE INVENTION

This problem is solved by a rear projection device according to Claim 1, a projection screen according to Claim 19, a rear projection method according to Claim 20, a method for the production of a projection screen according to Claim 23, as well as by a use of a rear projection device according to Claim 30. Advantageous configurations and improvements are specified in the respective dependent claims.

A rear projection device according to the invention for representing at least static images comprises at least one projection screen and at least one light source with an emission spectral range provided for rear projection onto the projection screen, which is adjusted to be selectively spectrally absorbent for an ambient light, at least outside of a spectrally narrowband transmission spectral range, wherein the projector permits a transmission of useful light inside the transmission spectral range.

The projection screen is constructed, for example, as a flat body. The projection screen is preferably a planar flat body. However, particularly in connection with a laser projection device, the projection screen can also have an at least simply curved surface. An outline of a flat projection screen is, for example, rectangular, polygonal, oval, round or in a generally irregular shape. In particular a projection device can comprise several projection screens arranged, for example, side by side. The projection screen preferably comprises a transparent substrate material. It is particularly preferred that the substrate material comprise glass or plastic. For example, a plastic film can be used as the substrate.

In particular, the light source is constructed in such a way that the projection screen can be selectively illuminated locally and preferably variably over time. In a first variant, for example, an image is projected onto the projection screen with the aid of a projection device. For this purpose, it is possible, in particular, to use projection devices of the type familiar for video projection or the like, for instance, particularly using a light valve or micromirror technology. In another variant, the picture is produced on the projection screen with the aid of at least one laser beam, for example. This preferably allows distortion-free representation on nonplanar surfaces. In particular, the projection device allows representation of moving images with an image frequency of at least 50 Hz, and preferably at least 100 Hz.

Ambient light is, for example, natural daylight or/and artificial light, particularly intended for lighting a space. The spectral range of the ambient light can thus cover the entire spectral range of light visible to the human eye.

The useful light spectral range preferably covers at least one narrow band subrange of the light spectrum visible to the human eye. The transmission spectral range likewise covers at least one narrowband subrange of the light spectrum visible to the human eye. According to one configuration, a narrowband subrange has a range between 100 nm and 50 nm, preferably between 50 nm and 20 nm, particularly preferably between 20 nm and 5 nm, as well as most preferably less than 5 nm. The range is defined, for example, on the basis of the corresponding width at half-maximum. The transmission spectral range indicates, in particular, the light spectral range usable for imaging. The useful light spectral range actually employed for the imaging can also be only a proper subset of this spectral range. This results from, for example, the choice of the emission spectral range of the light source.

A degree of absorption of ambient light by the projection screen, at least outside of a useful light spectral range, is preferably greater than 65%, more preferably greater than 80%, particularly preferably greater than 90% and most preferably greater than 95%, relative to an intensity of the vertically incident ambient light on the projection screen. The absorption factor is preferably also maintained using an averaging over a range of angles of incidence. In a first variant, the absorption is limited such that these specified values are satisfied in case of a spectrally integrated intensity of the ambient light. In particular, an absorption in a spectral range in which the human eye has low sensitivity can be smaller than in a spectral range with high relative optical sensitivity. For an optimal compromise between transmission of useful light and absorption of ambient light, it can also be appropriate to allow a spectrally varying absorption outside of the transmission spectral range. In another variant, the specified absorption values for each wavelength of the ambient light spectral range are maintained, at least outside of the transmission spectral range. It is advantageous for reflectance of ambient light to be suppressed or at least minimized. Without rear projection, the screen preferably looks basically dark to a viewer. The screen can produce a dark color impression such as dark-violet. It is particularly preferable, however, for the absorption to be adjusted such that the screen appears grey or black and thus uncolored.

In a preferred configuration, the emission spectral range of the light source lies at least in part inside the transmission spectral range. The latter is formed, in particular, by at least one spectrally narrowband subrange of the light spectrum visible to the human eye. The useful light spectral range employed for imaging can be understood as the intersection set of the emission and the transmission spectral ranges. In a first variant, for instance, the transmission spectral range is exceeded spectrally by the emission spectral range of the light source. Thus only part of the emission spectral range is transmitted by the projection screen. In another variant, an emission spectral range of the light source has a narrower band, for example, than the narrowband useful light spectral range. This is achieved by using, for instance, at least one monochromatic laser, which preferably has a bandwidth less than 1 nm. This can likewise be the case if an LED having, for instance, a spectral bandwidth less than 30 nm is used. The transmission and the spectral ranges are preferably matched to one another such that the useful light spectral range corresponds at least approximately to the transmission spectral range. A bandwidth of the narrowband subrange of useful light is preferably between 100 nm and 50 nm, more preferably between 50 nm and 20 nm and particularly preferably less than 20 nm. The bandwidth of the spectral ranges in each case is relative to the width at half-maximum.

In the first variant, a monochromatic image can be generated using a single spectrally narrowband subrange of useful light.

For generating colored images it is provided, in particular, that the useful light spectral range is formed by at least three narrowband, more particularly, disjoint, subranges of the light spectrum visible to the human eye. The three narrowband subranges each lie, for instance, in the range of a primary color. A primary color here is in particular one of the three implementation-determined primary colors of a color space to be imaged. The primary colors are, for instance, red, green and blue, with which a white or uncolored hue can be mixed additively. Other primary colors can also be used however. With regard to a definition of a primary color, as well as additive color mixing and color science, reference is made to the Manfred Richter monograph, “Einführung in die Farbmetrik,” [Introduction to Color Science], 1981, Berlin, De Gruyter, which is incorporated by reference into the scope of the disclosure. An example of a triplet of spectrally pure primary colors is 447 nm (blue), 532 nm (green) and 627 nm (red). Another example of a triplet of primary colors is 445 nm (blue), 546 nm (green) and 632 nm (red). Other values can be used in addition to these, the primary colors lying respectively between 420 nm and 460 nm, between 520 nm in 560 nm, and between 600 and 640 nm. Primary colors that are not spectrally pure can also be used, by employing spectral ranges with a finite width at half-maximum. The width at half-maximum is preferably between 100 nm and 50 nm, which can be achieved for instance with a color filter in conjunction with a spectrally broadband light source. It is further preferred that it lies between 50 nm and 20 nm and particularly preferred that it lies between 20 nm and 5 nm, which can be achieved with LED or laser illumination. It is most preferably less than 5 nm, which can be achieved with a laser. Moreover, more than three primary colors can be used. Particularly by using monochromatic primary colors, which can be provided, for instance, by a respective laser for each, a large color space can be covered with pure primary colors.

It is particularly preferable to provide at least one laser and/or one light-emitting diode (LED), particularly in the spectral range of a primary color. In another configuration, a broadband light source in conjunction with a spectral range decomposition is provided as a light, in particular, for providing at least one spectral range of a primary color. A halogen lamp, a gas discharge lamp or the like can be used as a broadband light source, for example. At least one color filter element is used for spectral range decomposition. A spectral range decomposition is preferably enabled with the aid of at least one color wheel. An example of a structure as well as a function of a color wheel follows from DE 197 08 949 A1, which is incorporated herein by reference.

The emission spectral range of the light source expediently comprises at least one of the three primary colors.

It is preferred that the projection screen comprise at least one dye and/or colored pigment and/or inorganic material absorbing in at least one light spectral range visible to the human eye at least outside the transmission spectral range. In particular, a dye and/or a colored pigment mixture is provided. Additionally, a metal oxide, nitride and/or carbide, for instance, is used as an inorganic material. In particular, by using various of the above-mentioned absorbing materials, the entire ambient light spectral range outside the transmission spectral range, particularly the useful light spectral range, can be absorbed.

Alternatively or in addition to the use of dyes, it is provided that the projection screen comprises metallic nanoparticles absorbing in at least one light spectral range visible to the human eye at least outside the transmission spectral range. Gold or silver is preferably used as metal, but other metals can also be used. The size of the metallic nanoparticles is preferably dimensioned such that they form surface plasmons in the light spectral range concerned. More preferably, the metallic nanoparticles display a spectrally narrowband absorption in their respective spectral range concerned. A bandwidth of the absorbing spectral range is preferably between 100 nm and 50 nm, more preferably between 50 nm and 20 nm, and particularly preferably less than 20. The spectral bandwidth is defined by the corresponding width at half-maximum. It is particularly preferred that an absorption spectral range be selectable by a narrow mean size distribution of metallic nanoparticles. A narrow mean size distribution has, for instance, a standard deviation of the size of between 10% and 3%, more particularly less than 3%. For instance, at least two different narrowband spectral ranges in which an absorption occurs can be provided by at least two different narrow mean size distributions.

It is particularly expedient if the metallic nanoparticles have a mean diameter between 100 nm and 200 nm, preferably between 60 nm and 100 nm, and particularly preferably between 5 and 60 nm. The mean diameter in this case is to be understood as the mean lateral extension, metallic nanoparticles preferably being formed roughly spherical, ellipsoidal and/or lamellar. By an appropriate size distribution of metallic nanoparticles, a superimposition of spectrally narrowband absorption ranges can preferably be achieved. It is thereby particularly preferred that at least one absorbing spectral range be provided between each two primary colors of the useful light.

Particularly if polarized useful light is used, it is advantageous if the metallic nanoparticles each have an anisotropic shape and are oriented in a preferred direction relative to the projection screen. For this purpose the metallic nanoparticles are, for example, acicular and/or lamellar. These nanoparticles preferably absorb different polarization directions of the useful light and the ambient light to different degrees. It is further preferred that the anisotropic nanoparticles be oriented in such a manner that one polarization direction of the useful light is less strongly influenced, while the generally isotropically polarized or nonpolarized ambient light is absorbed nearly uniformly. For instance, ellipsoidal nanoparticles are oriented with a long axis in a plane of the projection screen along a respective polarization direction of an electrical field vector of a linearly polarized useful light beam incident on the projection screen. An absorption due to surface plasmons takes place, for instance, in the range of a first wavelength. Preferably a light beam with a polarization adjusted perpendicular to the longitudinal axis is absorbed, however, in a range of a second wavelength different from the first one. It is particularly preferable that enhanced contrast be achieved between the transmitted useful light and the ambient light reflected from the surface of the projection screen. In particular, an acute-angle absorption of the ambient light is adjusted. In this way, for instance, ambient light coming from directions in which the useful light need not be transmitted can be absorbed more strongly than can light from other directions.

Particularly if three primary colors at 447 nm, 532 nm and 629 nm are used, it is provided that the projection screen absorbs in a first spectral range between 447 nm and 532 nm, and in a second spectral range between 532 nm and 629 nm, as well as in particular in the ultraviolet spectral range and/or in the infrared spectrum range. An absorption in the first spectral range between 447 nm and 532 nm is achieved, for instance, with pyrromethene 546. A blocking in this spectral range is alternatively achieved with the dye DOCI (3,3′-dimethyloxacarbocyanine iodide). An absorption in the second spectral range between 532 and 629 nm is achieved for instance with the dye DODCI (3,3′-diethyloxadicarbocyanine iodide) or alternatively with the dye DQOCI (1,3-diethyl-4,2-quinolyloxacarbocyanine iodide). An absorption in the ultraviolet spectral range is achieved, in particular, with the dye coumarin 102. In the infrared spectral range, the dye cryptocyanine is used. The aforementioned dyes can be obtained in Germany as laser dyes from the firm Lambda Physik AG, Hans Böckler Strasse 12, D-37309 for instance. Alongside the above-mentioned dyes, additional laser dyes can be used, particularly in a combination. With regard to the above-mentioned and additional laser dyes, reference is made within the scope of the disclosure to the catalog “Lambdachrome® Laser Dyes,” 3rd edition (2000), Ulrich Brackmann, Lambda Physik AG, Hans-Böckler-Strasse 12, D-37079, Germany. Dyes are preferably applied in the form of a thin film or film stack to the side of the projection surface projection screen that is turned towards the viewer or away from the viewer. They can likewise be provided on both sides. The concentration and/or the layer thickness is dimensioned such that the above-mentioned absorption degrees are achieved. For the boundaries of the respective spectral range, it is preferable to use a 10% width, i.e., wavelength values at which the associated absorption has declined to 10% of a peak value of the corresponding absorption characteristics. In particular, metallic nanoparticles are used in addition to dyes.

In a first variant, the metallic nanoparticles are applied to a surface of the projection screen. In a second variant, it is provided that the projection screen comprises a matrix for embedding at least one material and/or dye and/or metallic nanoparticles that absorbs in at least one light spectral range visible to the human eye, in particular, outside the useful light spectral range. This can be, for instance, a polymeric or inorganic matrix. As an inorganic matrix, a metal oxide, a metal nitride or a metal carbide is used, for example. Particularly in order to avoid reflections, an index of refraction of the matrix is matched to the index of refraction of a substrate material of the projection screen such that the indexes of refraction are at least approximately equal. The matrix can be applied to the substrate of the projection screen in the form of one or more layers. In another configuration, the substrate material of the projection screen can also form the matrix. For the embedding of metallic nanoparticles into the matrix it is provided that the dimensions of the particles are adapted corresponding to the matrix material that is used.

In another variant it is preferably also provided for the projection screen to comprise an interference layer system, comprising at least one layer, for influencing the transmission spectral range. This interference layer system preferably comprises one or more dielectric layers. Preferably, a spectral emission characteristic of the light source is also corrected with the aid of this coating, for instance in order to improve a white balance. An interference layer system having, in particular, a transmission in the range of each primary color and otherwise having a nearly complete reflection for an emission spectral range of the light source, can additionally be provided on a side of the projection screen facing the light source.

For an improved radiation characteristic of the projection screen surface, the projection screen comprises at least one scattering element. The scattering element is formed for instance by a rough surface of the projection screen. In particular, the rough surface has roughness structures that are larger than the wavelengths of the light spectral range visible to the human eye. A surface topography is preferably constructed such that a three-dimensionally anisotropic scattering characteristic is produced, as described for example in DE 102 45 881 A1, which is hereby incorporated into the scope of disclosure by reference. Additionally or alternatively, a separate scattering element inserted into a beam path of the rear projection device can be provided. The scattering element can be provided on the side of the projection screen facing the light source as well as on that which faces away from the light source.

It is particularly advantageous if the projection screen has an anti-reflection coating on the front side. This involves, for instance, a dielectric anti-reflection coating consisting of one or more dielectric layers. The reflection can additionally be substantially reduced with the aid of surface structures that are smaller than the light wavelength of the ambient light, for example. In particular, these surface structures achieve an index of refraction that diminishes towards the surface. Such reflection reducing coatings are known, for instance, as so-called “moth's eye structures.” Such moth's eye structures can be provided on a surface of the substrate or/and on a coating situated there.

It is additionally expedient if the projection screen comprises an antistatic coating. For instance, an electrically conductive and, in particular, transparent layer is used for this purpose. For example, it is possible to use one or more thin metal films, particularly in conjunction with at least one dielectric layer. An adhesion of dust particles due to an electrical charge is preferably avoided. It is particularly preferred that undesired light scattering effects of such dust particles are thereby reduced. An antistatic coating is preferably placed on a side of the projection screen facing away from the light source. Additionally, however, an antistatic coating can be applied to a side of the projection screen facing the light source.

In order to avoid heating of the projection screen due to irradiation by ambient light such as sunlight, it is provided that the projection screen comprises a coating that reflects infrared radiation. The latter is preferably applied to a side of the projection screen facing away from the light source. It is preferably a transparent conductive film. For instance, one or more transparent conductive oxide films are used here. Alternatively or additionally, one or more thin metal films are used, particularly in combination with at least one dielectric layer. More particularly, a cooling device such as a fan is additionally provided to cool the projection screen.

The projection screen preferably comprises a speckle-reducing surface topography. Speckles in case of an illumination with laser radiation are avoided or at least reduced thereby. For instance, the topography of the surface is constructed such that parts of the surface lying in each light spot of the laser beam deflect the laser radiation in different directions during transmission, so that the formation of interference-capable wave fronts due to points whose separation lies below the resolving power of the eye are reduced. A surface topography comprises, for instance, wavelike or calotte-like structures. In this regard, DE 10 2004 042 648 A1 is incorporated into the scope of the disclosure by reference. The topography of the surface there is constructed such that parts of the surface lying in each light spot of a laser beam reflect the laser radiation in different directions, so that a reflectance of interference-capable wave fronts by points whose separation lies below the resolving power of the eye is reduced. This principle is applied correspondingly to transmission, in which case a refraction on the surface is used for beam deflection instead of a reflection on the surface.

The invention additionally relates to a projection screen for a rear projection device, in particular, according to a configuration described above, with at least one light source, which is provided for rear projection onto the projection screen that is adjusted to be spectral-selectively absorbent for an ambient light, at least outside of a spectrally narrowband transmission spectral range, wherein the projection screen permits a transmission of useful light inside the transmission spectral range.

An additional subject matter of the invention is a method for the representation of at least static images, wherein the projection screen is illuminated by a light source with an emission spectral range visible to the naked eye, wherein useful light in a transmission spectral range that is formed by at least one narrowband subrange of the visible light spectrum is spectral-selectively transmitted through the projection screen, and visible ambient light, at least outside the transmission spectral range of the projection screen, is at least nearly completely absorbed. Preferably, a degree of obstruction of ambient light by the projection screen, at least outside of a useful light spectral range, is greater than 65%, more preferably greater than 80%, particularly preferably greater than 90% and most preferably greater than 95%, relative to an intensity of the incident ambient light striking the projection screen at a right angle. The absorption degree is preferably achieved, even on the basis of averaging across a range of angles of incidence. In a first variant, the absorption is dimensioned such that these indicated values are satisfied in the case of a spectrally integrated intensity of the ambient light. In another variant these indicated values are satisfied for every wavelength of the ambient light spectrum.

Preferably, at least one static and/or moving colored image is rear-projected onto the projection screen with at least three primary colors, more particularly, with one laser and/or one LED each.

Particularly for the rear projection of moving images, algorithms can be used to calculate dynamic amplification curves for primary colors on the basis of previously shown and yet-to-be-shown images, and modify them to achieve an impression of an enhanced color saturation and/or an increased contrast. Optimized electronic interfaces are additionally used to minimize errors due to image noise caused by signal noise.

Additionally, a polarization-dependent absorption and/or transmission, particularly in the range of at least one primary color, is achieved by means of metallic nanoparticles that have an anisotropic form and are oriented in a preferred direction relative to the projection screen. It is particularly preferred that a contrast be achieved between the transmitted useful light and the reflected ambient light.

The invention further relates to a method for manufacturing the projection screen of a rear projection device according to one of the above-described configurations, wherein at least one material or/and at least one dye or/and metallic nanoparticles absorbing in at least one light spectral range visible to the human eye outside the transmission spectral range and, in particular, the useful light spectral range, is applied to a precursor product of the projection screen. The precursor product is, for example, a substrate of the projection screen. It can additionally be a substrate of the projection screen coated with at least one layer. The absorbing material and/or dye is applied to the substrate material of the projection screen in, for instance, individual layers in layer thicknesses between 500 nm and 100 nm each, preferably in a layer thickness range of 10 to 100 nm. Particularly for an inorganic absorbing material, the coating can be performed by means of a physical vacuum deposition method (PVD) such as vapor deposition, sputtering, magnetron sputtering or the like. A physically supported chemical vacuum deposition method such as (CVD, PECVD) is additionally provided for coating.

The metallic nanoparticles can likewise be applied to the surface of the substrate. The dye and/or nanoparticles are particularly advantageously embedded into a matrix, in particular, a substrate material of the projection screen.

It is additionally advantageous to apply the matrix to the precursor product of the projection screen by means of spraying, doctor-blade coating, brushing, a sol-gel method or/and vapor deposition.

In a preferred configuration, at least one dye is embedded in the matrix by means of vapor co-deposition of dye and matrix. In particular, the matrix and the dye are simultaneously vapor-deposited on a precursor product of the projection screen. It is particularly expedient to apply a thermal vapor deposition method in this regard. An inorganic matrix is preferably used for this purpose. In another variant, however, an organic matrix can also be used.

For the production of metallic nanoparticles it is provided in the first variant that the metallic nanoparticles are produced by means of electron beam lithography. Metal particles in a defined geometry are preferably produced with the aid of the electron beam lithography. It is particularly preferred that nanoparticles are prepared in a two-dimensional arrangement relative to one another. In particular, surfaces with a regular or stochastically distributed arrangement of nanoparticles over the surface are produced.

In an additional variant for the production of nanoparticles, the nanoparticles are produced by means of at least one physical vacuum deposition method. A plasma ion supported method is preferably used for this. It is additionally preferable if at least one method from the group comprising magnetron sputtering, ion beam sputtering and arc coating is used. It is particularly preferred that nanoparticles be produced with an electron beam vapor deposition method as described, for instance, in the publication “The optical response of silver island films embedded in fluoride and oxide optical materials,” Stenzel et al., Physics, Chemistry and Application of Nanostructures (2003), pages 158 ff. This publication is incorporated into the scope of the disclosure by reference.

A printing method can also be provided for manufacturing nanoparticles. A printing method in this regard can contain, in particular, a local functionalization of a surface. A barrier discharge, for example, is used for this purpose. A local surface activation can be performed by means of a barrier discharge, particularly to influence a layer adhesion and a subsequent printing process. This is preferably used for a locally selective coating.

A combination of the above methods can be used, in particular for manufacturing a projection screen as well as metallic nanoparticles.

Finally, the invention relates to a use of a rear projection device according to Claim 1, particularly according to one of the above-described configurations, as a display element in an environment illuminated by daylight or/and artificial light. For instance, use of the projection device in an outside application is envisioned, for example, as a display element in a stadium or the like. A rear-projected image is preferably clearly recognizable even in bright daylight. Use of the rear projection device inside buildings is also provided. The rear projection device is preferably used in places where a reduction of ambient light is impossible or undesirable. For instance, the rear projection device is provided as a display element in publicly accessible halls such as train station halls.

### BRIEF DESCRIPTION OF THE DRAWINGS

The invention will be described in detail below on the basis of the drawings. The characteristics there are not limited, however, to the individual configurations. Instead the characteristics specified in the respective drawings or/and in the description, including the description of figures, can be combined for improvements.

What is shown are:

FIG. 1, a first rear projection device,

FIG. 2, a second rear projection device,

FIG. 3, a spectral absorption curve of a projection screen,

FIG. 4, a spectral transmission curve of a projection screen,

FIG. 5, an absorption characteristic of various metallic nanoparticles,

FIG. 6, an absorption characteristic of coumarin 120,

FIG. 7, an absorption characteristic of pyrromethene 546,

FIG. 8, an absorption characteristic of DODCI,

FIG. 9, an absorption characteristic of cryptocyanine,

FIG. 10, an absorption characteristic of DOCI, and

FIG. 11, an obstruction characteristic of DQOCI.

### DETAILED DESCRIPTION OF THE PREFERRED EMBODIMENTS

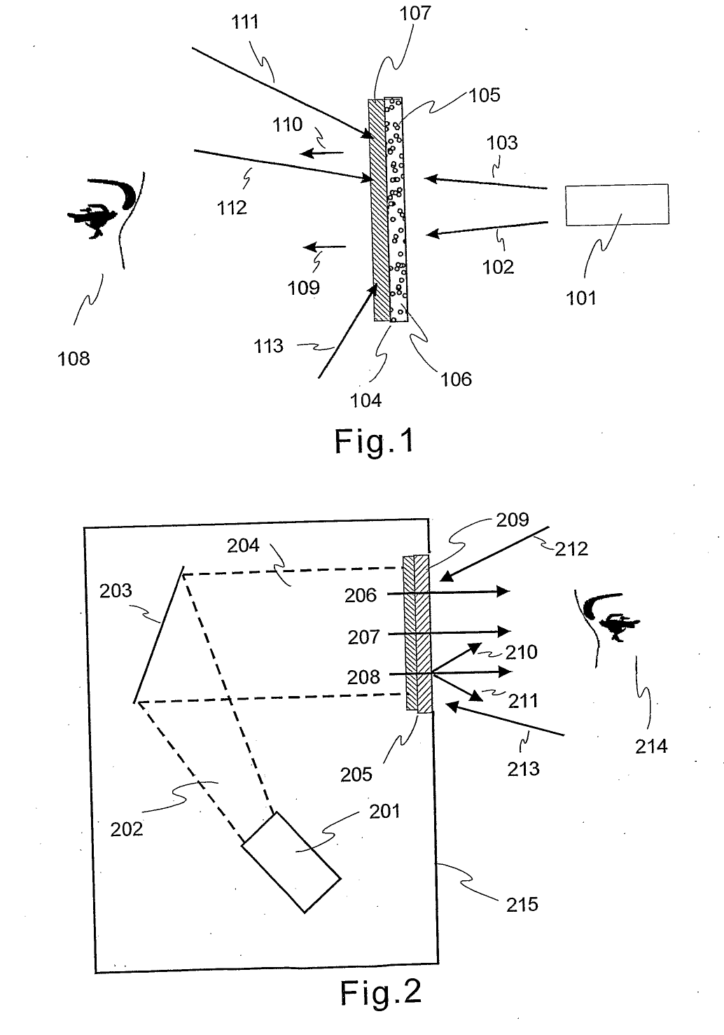

FIG. 1 schematically shows a first rear projection device. A first light source 101 with an image generation device, not illustrated separately, contained therein emits a first useful light beam 102, shown here as an example, as well as a second light beam 103, which strike first projection screen 104. On a side facing first light source 101, the latter has a substrate 105 with metallic spectral-selectively absorbing nanoparticles 106 embedded in a matrix of the substrate material. First projection screen 104 further comprises a first spectral-selectively absorbing layer 107. The useful light beams are transmitted to first projection screen 104, so that a first transmitted useful light beam 109 and a second transmitted useful light beam 110 exit on the side facing first viewer 108. Furthermore, a first, a second and a third ambient light beam 111, 112, 113, for example, are shown, which are incident on first projection screen 104 from the side facing first viewer at 108. Due to the first spectral-selectively absorbing layer 101 and the spectral-selectively absorbing nanoparticles, reflectance of the incident ambient light beams is negligible, so that first viewer 108 perceives only the transmitted useful light beams 109 and 110 shown for the sake of example.

The first light source with integrated image generation device is, for example, a projection device, not shown in detail, analogous to a video projector. It is preferably also a laser image generation device.

FIG. 2 shows a second rear projection device. A second light source 201 emits a first light beam bundle 202, which illuminates a micromirror array 203. The latter is equipped with a plurality of micromirrors, not shown, for each of the three primary colors red and green and blue. The micromirrors reflect the received light in the second light beam bundle 204 onto a second projection screen 205. The micromirrors are arranged such that, for each pixel, a respective mirror for each color can switch on/off on second projection screen 205. Second light source 201 comprises a red, a green and a blue primary color. These can be generated, for example by means of a spectral decomposition, not shown, of a broadband light source. The decomposition can be performed, for instance, with a color wheel. In a different variant, likewise not shown, there are laser-based primary colors. Second projection screen 205 is again spectral-selectively absorbing for ambient light visible with the human eye. On the other hand, useful light in a transmission spectral range is transmitted. The transmission spectral range is formed by a respective narrowband red, blue and green spectral range. Thus a red light beam 206, a green light beam 207 and a blue light beam 208, an example of each of which is shown, pass substantially unhindered through second projection screen 205. Because of the use of diffuser 209, there is a scattering of the transmitted light beams, so that a first scattered beam 210 and a second scattered beam 211 result, as shown here on the example of the blue light beam 208. In addition, a number of other scattered light beams arise. Due to the spectral-selective absorption of the second projection screen 205, a fourth ambient light beam 212 and a fifth ambient light beam 213 are absorbed by second projection screen 205, so that reflectance of the ambient light beams is negligible. A second viewer 214 therefore sees only the useful light beams in this instance, shown for the sake of example as a red light beam 206, green light beam 207 and blue light beam 208, as well as the corresponding scattered light beams.

The second rear projection device further comprises a housing 215 that prevents a direct exit of the light emitted by the second light source. In particular, housing 215 ensures that second observer 214 cannot be injured by direct laser beams once the laser beams are used as second light source 201.

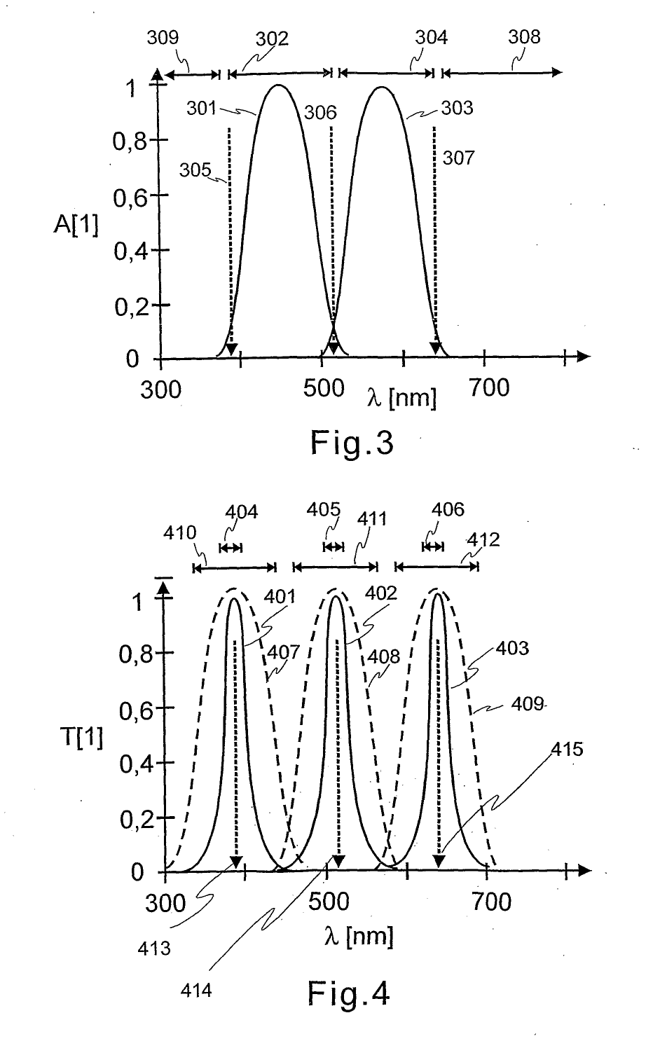

FIG. 3 shows a schematic spectral absorption curve of a projection screen. The diagram shows a first absorption curve 301 that defines a first absorption spectral range 302, which is defined by a 10% width in this case. The diagram additionally shows a second absorption curve 303, which defines a second absorption spectral range 304, the latter again being determined by a corresponding 10% width. The spectral positions of a first primary color 305, a second primary color 306 and a third primary color 307, each representing spectrally pure primary colors, are also plotted in the diagram. In this example, these primary colors lie at 447 nm, 532 nm and 627 nm, and thus form a blue, a green and a red primary color. In addition to the first absorption spectral range 302 and the second absorption spectral range 304, an absorption, not shown here, in the near infrared spectral range 308 and/or in the ultraviolet spectral range 309 can be provided. In the example shown, the first absorption range is formed by pyrromethene 546, and the second absorption range by DODCI. The primary colors 447 nm, 532 nm and 627 nm are realized, for example, by using a solid-state laser with frequency doublers.

FIG. 4 shows a schematic spectral transmission curve of a projection screen. The diagram shows a first transmission spectral curve 401, a second transmission spectral curve 402 and a third transmission spectral curve 403. These transmission spectral curves are defined, similarly to the curve shown in FIG. 3, by an appropriate spectral-selective absorption of the projection screen. Associated with these transmission spectral curves are a first, second and a third transmission spectral range 404, 405, 406 respectively, the transmission spectral ranges each being defined by 10% width. The diagram further shows a first emission spectral curve 407, a second emission spectral curve 408, as well as a third emission spectral curve 409, wherein these are each normalized to the value “1.” Again, a first emission spectral range 410, a second emission spectral range 411 and a third emission spectral range 412 can be associated with these emission spectral curves on the basis of the width at half-maximum. In this case, the emission spectral ranges 410, 411, 412 exceed the associated transmission spectral ranges 404, 405, 406. Consequently, only a portion of the light emitted by the light source is transmitted as useful light, while the other portions are absorbed. The emission spectral curves are formed, for example, by spectral decomposition of a broadband light source by means of color filters, for instance. A first laser wavelength 413, a second laser wavelength 414 and a third laser wavelength 415 are additionally plotted in the diagram. These are the wavelengths 447 nm (blue), 532 nm (green) and 627 nm (red). In this case only a small subrange of the respected transmission spectral ranges is used for the transmission of useful light.

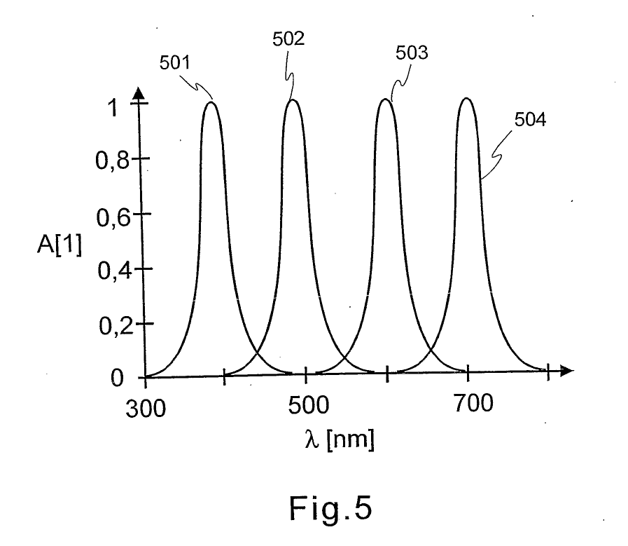

FIG. 5 shows a schematic absorption characteristic of various metallic nanoparticles. The diagram shows a first, a second, a third and a fourth characteristic absorption curve 501, 502, 503, 504, respectively. These spectral absorption curves are each associated with a mean size of metallic nanoparticles. The size of the metallic nanoparticles increases from small to large wavelengths in the diagram from left to right.

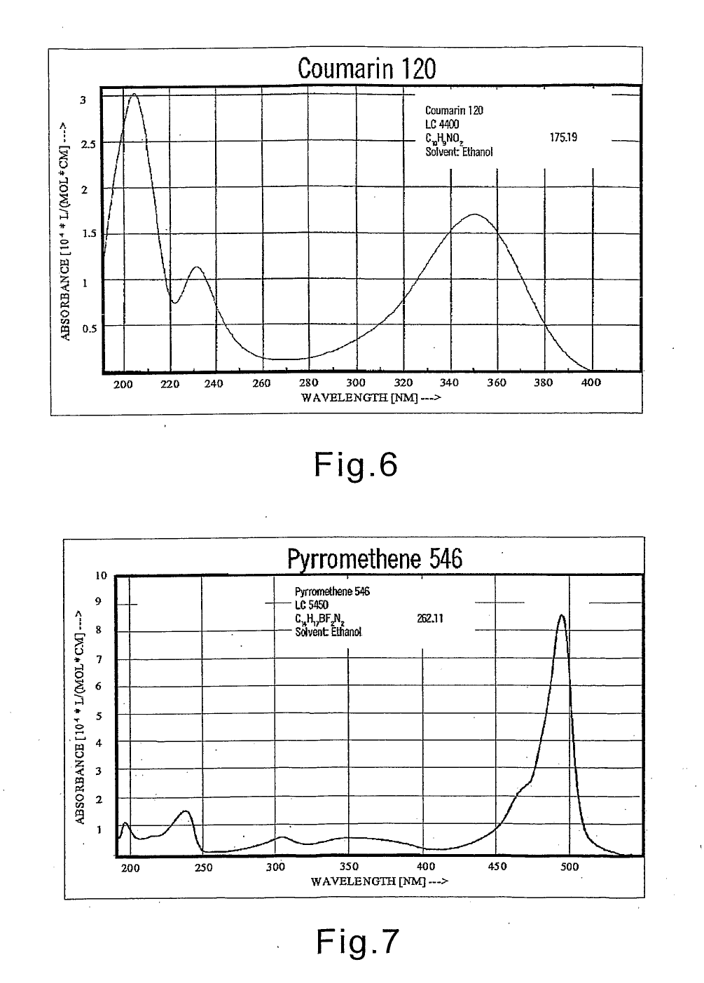

FIGS. 6-11 show absorption characteristics of various dyes, which can be obtained in Germany, for example, as laser dyes from Lambda Physik AG, Hans-Böckler-Strasse 12, D-37079.

On the abscissa of each of the diagrams shown, a respective light wavelength in nanometers is plotted. On the ordinate, a respective molar extinction coefficient in 10-4 L/(mol cm) is plotted. Ethanol is used as a solvent for each of the dyes. For details, incorporated into the disclosure, regarding the dyes, the reader is referred to the catalog “Lambdachrome® Laser Dyes,” 3rd edition (2000), Ulrich Brackmann, Lambda Physik AG, Hans-Böckler-Strasse 12, D-37079, Germany.

FIG. 6 shows an absorption characteristic of coumarin 120. This dye is preferably used to achieve an absorption in the near ultraviolet spectral range.

FIG. 7 shows an absorption characteristic of pyrromethene 546. This dye is used, for instance, for absorption in the spectral range between a blue and a green primary color.

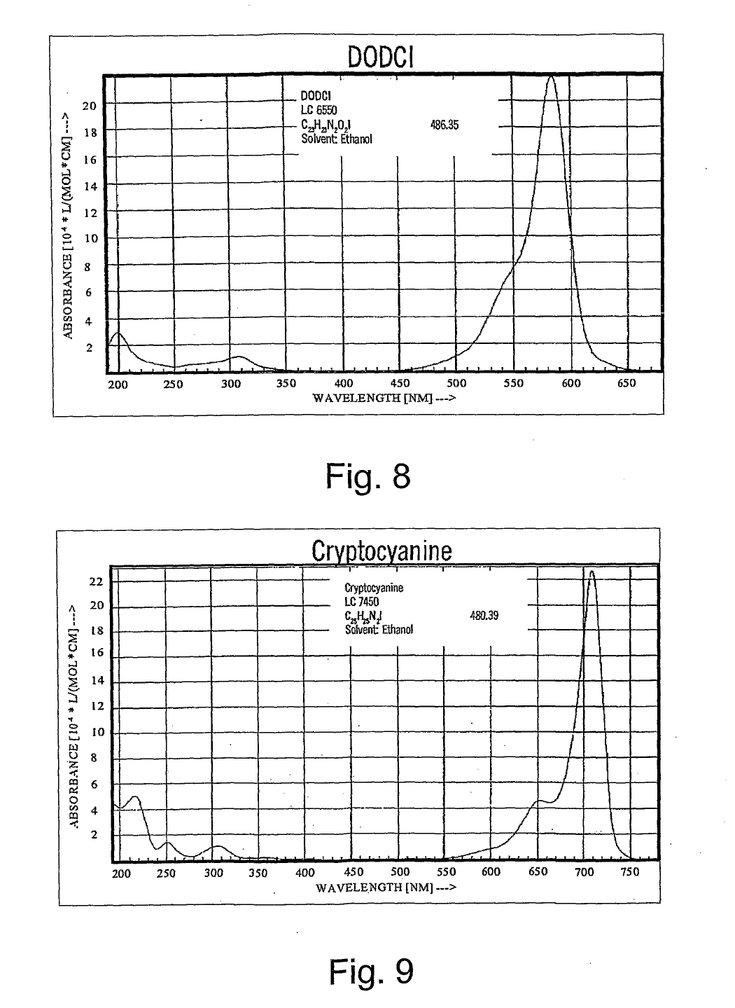

FIG. 8 shows an absorption characteristic of DODCI. With this dye, an absorption in a spectral range between a green and a red primary color can be provided.

FIG. 9 shows an absorption characteristic of cryptocyanine. This dye primarily provides an absorption in a near-infrared spectral range.

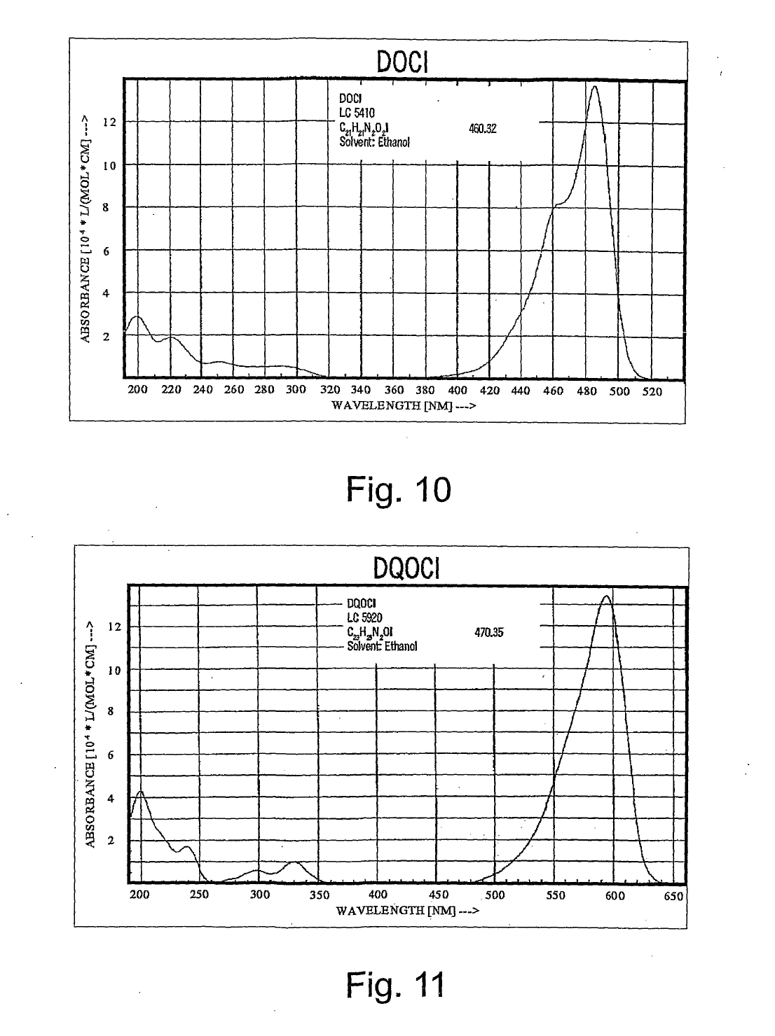

FIG. 10 shows an absorption characteristic of DOCI. This dye can be used alternatively or in addition to pyrromethene 546 to provide an absorption in a spectral range between a blue and a green primary color.

FIG. 11 shows an absorption characteristic of DQOCI. Additionally or alternatively to DODCI, this dye can be used particularly to provide an absorption in a spectral range between a green and a red primary color.

1. A rear projection device for representing at least static images, comprising at least one projection screen (104; 205) and at least one light source (101; 201) with an emission spectral range (410; 411; 412) for rear projection onto a screen adjusted to be spectral-selective absorbing for an ambient light at least outside of at least one spectrally narrowband transmission spectral range (404; 405; 406), wherein projection screen (104; 205) permits a transmission of useful light inside the transmission spectral range (404; 405; 406).

2. The rear projection device according to claim 1, characterized in that emission spectral range (410; 411; 412) lies, at least in part inside transmission spectral range 404; 405; 406).

3. The rear projection device according to claim 1, characterized in that transmission spectral range (404; 405; 406) is formed by at least three narrowband subranges, in particular, one in the range of each primary color (305; 306; 307) of the light spectrum visible to the human eye.

4. The rear projection device according to claim 1, characterized in that at least one laser or/and LED, more particularly in the spectral range of one primary color (305; 306; 307), is provided as light source (101; 201).

5. The rear projection device according to claim 1, characterized in that A spectrally broadband light source in combination with a spectral range decomposition, particularly for providing at least one spectral range of a primary color (305; 306; 307), is provided as light source (101; 201).

6. The rear projection device according to claim 1, characterized in that emission spectral range (410; 411; 412;) Of light source (101; 201;) comprises spectral ranges of at least three primary colors (305, 306, 307).

7. The rear projection device according to claim 1 characterized in that projection screen (104; 205) comprises at least one dye and/or color pigment and/or at least one inorganic material that is absorbing in at least one light spectral range visible to the human eye.

8. The rear projection device according to claim 1, characterized in that Projection screen (104; 205) comprises metallic nanoparticles absorbing in at least one light spectral range visible to the human eye.

9. The rear projection device according to claim 1 characterized in that the metallic nanoparticles have a mean diameter between 100 nm and 200 nm, preferably between 60 and 100 nm, and particularly preferably between 5 and 60 nm.

10. The rear projection device according to claim 8, characterized in that the metallic nanoparticles each have an anisotropic form and are oriented in a preferential direction relative to the projection screen (104; 205).

11. The rear projection device according to claim 1, characterized in that projection screen (104; 205) absorbs in a first spectral range (302) between 447 nm and 532 nm and a second spectral range (304) between 532 nm and 629 nm, as well as, in particular, in the ultraviolet spectral range (309) and/or in the infrared spectral range (308).

12. The rear projection device according to claim 1, characterized in that the projection screen (104; 205) comprises a matrix for embedding at least one material and/or one dye and/or metallic nanoparticles absorbing in at least one light spectral range visible to the human eye.

13. The rear projection device according to claim 1, characterized in that projection screen (104; 205) comprises an interference layer system comprising at least one layer for influencing the transmission spectral range.

14. The rear projection device according to claim 1, characterized in that the projection screen (104; 205) comprises at least one scattering element (209.)

15. The rear projection device according to claim 1, characterized in that the projection screen (104; 205) comprises An antireflection coating on a front side.

16. The rear projection device according to claim 1, characterized in that projection screen (104; 205) comprises an antistatic coating.

17. The rear projection device according to claim 1, characterized in that projection screen (104; 205) comprises a coating reflecting infrared rays.

18. The rear projection device according to claim 1, characterized in that projection screen (104; 205) comprises a speckle-reducing surface topography.

19. A projection screen for a rear projection device according to claim 1.

20. A method for representing at least static images, wherein a projection screen (104; 205) is illuminated for rear projection by a light source (101; 201) with an emission spectral range (410; 411; 412) visible to the human eye, wherein useful light in a transmission spectral range (404; 405; 406) that is formed by at least one narrowband subrange of the visible light spectrum is transmitted spectral-selectively through a projection screen (104; 205), and visible ambient light, at least outside transmission spectral range (404; 405; 406), is at least nearly completely absorbed by projection screen (104; 205).

21. The method according to claim 20, characterized in that at least one static and/or moving colored image is rear-projected onto projection screen (104; 205) with at least three primary colors (305; 306; 307), in particular, with at least one respective laser and/or one LED.

22. The method according to claim 20, characterized in that a polarization-dependent absorption and/or transmission, in particular, in the range of at least one primary color (305; 306; 307), is achieved by means of metallic nanoparticles that have an anisotropic form and are oriented in a preferential direction relative to projection screen (104; 205).

23. A method for manufacturing a projection screen (104; 205) of a rear projection device wherein at least one material or/and at least one dye or/and metallic nanoparticles that absorb in at least one light spectral range visible to the human eye outside the transmission spectral range (404; 405; 406) is applied to a precursor product of projection screen (104; 205).

24. The method according to claim 23, characterized in that the dye or/and the nanoparticles are embedded in a matrix, in particular, in a substrate material of projection screen (104; 205).

25. The method according to claim 24, characterized in that the matrix is applied to a precursor product of projection screen (104; 205) by means of spraying, doctor-blade coating, brushing, sol-gel methods or/and vapor deposition.

26. The method according to claim 24, characterized in that at least one dye is embedded into the matrix by means of co-deposition of dye and matrix.

27. The method according to, claim 23, characterized in that the nanoparticles are produced by means of electron beam lithography.

28. The method according to claim 23, characterized in that the nanoparticles are produced by means of electron beam lithography.

29. The method according to claim 23, characterized in that the nanoparticles are produced by means of at least one physical vacuum deposition method.

30. The method according to claim 23, characterized in that the nanoparticles are produced by means of a print method.

31. Use of a rear projection device according to claim 1 as a display element in an environment illuminated with daylight and/or artificial light.
